(19) United States
(12) Patent Application Publication
(10) Pub. No.: US 2017/0182685 A1
(43) Pub. Date: Jun. 29, 2017

(54) MULTI-NIP TAKEOFF

(71) Applicant: GRAHAM ENGINEERING CORPORATION, York, PA (US)

(72) Inventors: Jingyi XU, York, PA (US); Dale Wayne LEIDY, JR., Celebration, FL (US)

(21) Appl. No.: 15/384,884

(22) Filed: Dec. 20, 2016

Related U.S. Application Data
(60) Provisional application No. 62/271,420, filed on Dec. 28, 2015.
(60) Provisional application No. 62/271,705, filed on Dec. 28, 2015.

(51) Int. Cl. B29C 43/22; B29C 59/02; B29C 43/58; B29C 43/46; B29C 43/52

(52) U.S. Cl. CPC B29C 43/22; B29C 43/46; B29C 43/52; B29C 43/58; B29C 59/02; B29C 2043/468; B29C 2043/5833; B29L 2007/002

(57) ABSTRACT

A method for nipping and cooling plastic sheet material and a multi-nip takeoff and cooling section having a first smoothing and a second smoothing roll. A position, calibration and cooling roll is positioned proximate to the second smoothing roll. The position, calibration and cooling roll is movable relative to the second smoothing roll. A first fixed calibration and cooling roll is positioned proximate the position, calibration and cooling roll. The first fixed calibration and cooling roll is in a fixed position relative to the second smoothing roll. A first movable calibration and cooling roll is positioned proximate the first fixed calibration and cooling roll The first movable calibration and cooling roll is movable relative to the first fixed calibration and cooling roll. Actuators cooperate with the position, calibration and cooling roll and the first movable cooling roll to provide both nip pressure and gap control.

### FIELD OF THE INVENTION

The invention is directed to a device, system and method for cooling and calibrating sheet material. In particular, the invention is directed to a multi-nip takeoff device which has a combination of fixed and movable rollers to properly cool and calibrate the material.

### BACKGROUND

The invention relates to a method for cooling flat plastic products, in which plasticized plastic compound is fed to a calender via a slot nozzle by means of an extruder and is rolled and calibrated to the desired shape in this calender between at least two smoothing rolls, after which the film or sheet produced in this way is fed to a chill section comprising a plurality of adjustable rolls and passes through this section until it is sufficiently cool and dimensionally stable, at least both the gap width between the rolls and the speed of the rolls being controllable by open- and/or closed-loop control.

Calenders for calibrating and cooling a plastic film or plastic sheet comprising at least two chill or calibrating rolls, a chill section being arranged downstream of the rolls are known in the art. For example EP 1600277 discloses a calender with a downstream chill section which has pairs of rolls arranged one behind the other.

In chill sections of this kind, the position of the rolls can be adjusted, thereby allowing the cooling capacity to be influenced. However, it has been found that, as the rolls are adjusted, the film passing through partially loses contact with the roll, thereby giving rise to differences in the cooling behavior of the film.

U.S. Pat. No. 8,262,966 discloses a method for cooling flat plastic products, in which plasticized plastic compound is fed to a calender via a slot nozzle by means of an extruder and is rolled and calibrated to the desired shape in this calender between at least two smoothing rolls, after which the film or sheet produced in this way is fed to a chill section comprising a plurality of adjustable rolls and passes through this section until it is sufficiently cool and dimensionally stable. Both the gap width between the rolls and the speed of the rolls are controllable by open- and/or closed-loop control. The degree of wrap of the flat plastic product around the respective roll is varied by adjusting the rolls in the chill section into a mutually offset arrangement, hence increasing or minimizing the cooling capacity. The center axis lines of the plurality of rolls of the chill section are held parallel to one another, allowing constant spacing to be maintained between the center axis lines of each two adjacent mating rolls of the plurality of rolls of the chill section. The center axis lines of said each two adjacent mating rolls define a geometric plane, with each plane being rotatable about one of the center axis lines during said adjustment operation of the rolls, thereby varying an angle between adjacent geometric planes. The rolls are in a bellows type configuration, where the planes are folds capable of unfolding relative to each other while pulled open but being connected at respective edges. This type of method and device is complicated and does not provide the ability to simply and accurately control the gaps between the rolls.

It would be beneficial to provide a takeoff feature for a calender which effectively cools and calibrates the material and which allows adjustment of the rolls in a controlled and simple manner.

### SUMMARY

It is an object of the invention to provide a multi-nip takeoff device, system and method that is simple in construction and offers enhanced operational features.

It is an object to provide a multi-nip takeoff device in which one or more stationary rolls are stationary and one or more movable rolls are movable relative to the stationary rolls. The movable rolls move to create the required gap between the stationary rolls and the movable rolls. The movable rolls are proximate to or adjacent to the stationary rolls.

It is an object to provide a multi-nip takeoff device in which the rolls are driven to provide both nip pressure and gap control. The drivers being located in such a way as to provide stiffness and precise position for final gap.

It is an object to provide a device and process of calibrating the multi-nip takeoff device which includes retracing the movable rolls such that the tops of the movable rolls are moved in line with a series of idler rolls that will facilitate an operator in threading up the machine with a starter sheet by providing basically a level surface on which to push the starter sheet through the machine.

It is an object to provide a device and process of calibrating the multi-nip takeoff device wherein when the movable rolls are in a retracted position, the movable roll support frame sits on a permanently mounted homing or zeroing fixture for each roll, thereby allowing the system to orient itself at power up without going through an elaborate homing sequence each time.

An embodiment is directed to a multi-nip takeoff and cooling section having a first smoothing and a second smoothing roll. A position, calibration and cooling roll is positioned proximate to the second smoothing roll. The position, calibration and cooling roll is movable relative to the second smoothing roll. A first fixed calibration and cooling roll is positioned proximate the position, calibration and cooling roll. The first fixed calibration and cooling roll is in a fixed position relative to the second smoothing roll. A first movable calibration and cooling roll is positioned proximate the first fixed calibration and cooling roll. The first movable calibration and cooling roll is movable relative to the first fixed calibration and cooling roll. A second fixed calibration and cooling roll is positioned proximate the first movable calibration and cooling roll. The second fixed calibration and cooling roll is in a fixed position relative to the second smoothing roll.

An embodiment is directed to a multi-nip takeoff and cooling section having a first smoothing and a second smoothing roll. A position, calibration and cooling roll is positioned proximate to the second smoothing roll. The position, calibration and cooling roll is movable relative to the second smoothing roll. A first fixed calibration and cooling roll is positioned proximate the position, calibration and cooling roll. The first fixed calibration and cooling roll is in a fixed position relative to the second smoothing roll. A first movable calibration and cooling roll is positioned proximate the first fixed calibration and cooling roll The first movable calibration and cooling roll is movable relative to the first fixed calibration and cooling roll. Actuators cooperate with the position, calibration and cooling roll and the first movable cooling roll to provide both nip pressure and gap control between the second smoothing roll and the position, calibration and cooling roll, between the position, calibration and cooling roll and the first fixed calibration and cooling roll, and between the first fixed calibration and cooling roll and the first movable calibration.

An embodiment is directed to a method for multi-nipping and cooling plastic sheet material, the method comprising: running the plastic sheet material through polishing rolls; running the plastic sheet material through calibration and cooling rolls; and adjustably nipping on each pair of respective calibration and cooling rolls, allowing for a gradual change to the thickness of sheet material until sheet material reaches a final calibration and cooling roll. The initial nipping load of the polishing rolls is reduced, allowing the size of the polishing rolls and the power needed to drive them to be reduced due to the multi-nipping technology.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

The present invention will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

FIG. 1 is a diagrammatic view of a first illustrative embodiment of a multi-nip takeoff device according to the present invention, the device is shown in an operational position, in which the sheet material is moved through the device.

FIG. 2 is a diagrammatic view of the multi-nip takeoff device of FIG. 1, the device is shown in a safety position which allows the sheet material to be threaded through the rolls.

FIG. 3 is a diagrammatic view of a second illustrative embodiment of a multi-nip takeoff device according to the present invention, the device is shown in an operational position, in which the sheet material is moved through the device.

FIG. 4 is a diagrammatic view of the multi-nip takeoff device of FIG. 2, the device is shown in a safety position which allows the sheet material to be threaded through the rolls.

FIG. 5 is an enlarged diagrammatic view of a primary roll and two position/calibration rolls of the device of FIG. 1.

FIG. 6 is an enlarged diagrammatic view of three position/calibration rolls of the device of FIG. 1.

FIG. 7 is a schematic view illustrating the forces acting on the calibration and cooling roll of the device of FIG. 1.

FIG. 8 is a diagrammatic view of an actuator for use with various adjustable rolls of the device of FIG. 1.

FIG. 9 is a diagrammatic view of an alternate illustrative multi-nip takeoff device, the device is shown in a safety position which allows the sheet material to be threaded through the rolls.

FIG. 10 is a diagrammatic view of the multi-nip takeoff device of FIG. 9, the device is shown in an operational position.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features; the scope of the invention being defined by the claims appended hereto.

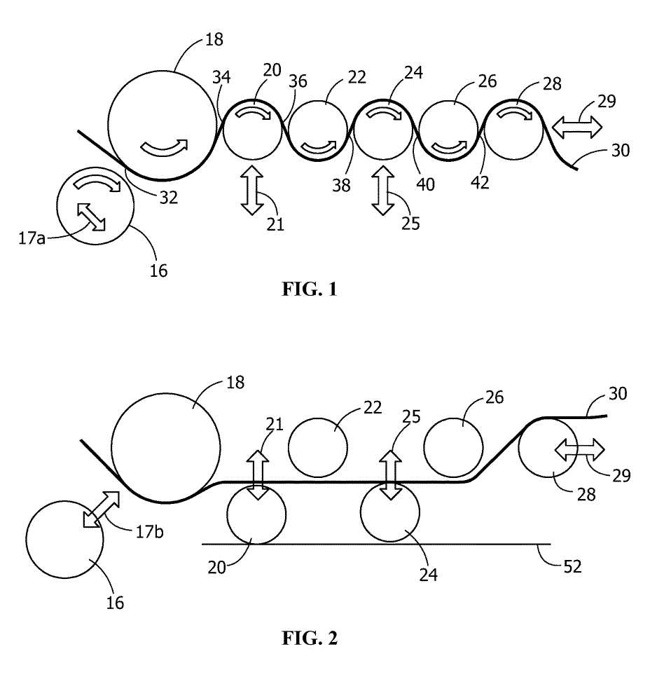

An illustrative multi-nip takeoff and cooling section 10 is shown diagrammatically in the illustrative embodiments of FIGS. 1 through 4, in relationship to a calendering device 12. The diagrammatic views illustrate a longitudinal section through all the rolls 20, 22, 24, 26, 28 of the multi-nip takeoff and cooling section 10. An extruder and sheet die (neither of these being shown) are situated ahead of this calender, on the left hand side in FIGS. 1 through 4. A wind-up system (not shown) for the film produced is situated after the chill section, to the right of FIGS. 1 through 4.

In the illustrative embodiments shown, the calendering device 12 has two polish or smoothing primary rolls 16, 18. In these embodiment, the smoothing roll 16 has a smaller diameter than the smoothing roll 18. However, the smoothing rolls 16, 18 can be either a combination of a larger roll and a smaller roll or two rolls of equal size, depending on the application.

The longitudinal axis of roll 16 is positioned at a 45 degree angle relative to the longitudinal axis of roll 18 and all fixed rolls 24, 28. However, roll 16 can be located in a position that is horizontal, or at any angle from 0 degree to 90 degrees, with respect to roll 18. The orientation changes can be accomplished by changing mounting hardware or other known methods of changing the orientation can be used.

The smoothing rolls 16, 18 function as cooling rolls and function as the primary or major nipping and polishing rolls. In the embodiments shown, approximately 80% to 90% of final thickness of the web of material 30 is formed by the movement and spacing of the smoothing rolls 16, 18.

Roll 20 functions as a position, calibration and cooling roll. Roll 20 is positioned proximate to or adjacent to smoothing roll 18. Roll 20 has a diameter which is smaller than the diameter of roll 18.

Rolls, 22, 24, 26, 28 have the same diameter as roll 20. These rolls perform 22, 24, 26, 28 both calibration (small nipping as further calibration of web thickness and surface polish) and cooling (with equal cooling for upper and lower surface of web on each pair rolls).

The longitudinal axis of roll 16, as shown in the illustrative embodiment of FIG. 1, is positioned at a 45 degree angle relative to the longitudinal axis of 20 and all fixed rolls 24, 28. However, roll 16 can be located in a position that is horizontal, or at any angle from 0 degree to 90 degrees, with respect to roll 20. The orientation changes can be accomplished by changing mounting hardware or other known methods of changing the orientation can be used.

In various illustrative embodiments, the nip roll 16 may have a skewing device which can compensate for some deflection of roll 16 at higher nipping force of thin gauge processing. With this skewing device the roll 16 can be made smaller than roll 18 to save cost. The manipulation and movement of the nip roller 16 is also made easier, allowing for the space or nipping gap 32 to be precisely established and maintained between the two primary rolls 16 and 18.

In the illustrative embodiment shown in FIGS. 1 and 2, rolls 18, 22, 26 are fixed or stationary and rolls 16, 20, 24, 28 can move in the directions shown by the respective arrows 17, 21, 25, 29 in FIGS. 1 and 2 to create the required nipping, or calibration gap and wrap angle for cooling between the adjacent roll pairs (i.e. gap 34 between roll 18 and roll 20, gap 36 between roll 20 and roll 22, gap 38 between roll 22 and roll 24, gap 40 between roll 24 and roll 26, and gap 42 between roll 26 and roll 28). The term fixed or stationary indicates that the respective rolls are not movable in the horizontal or vertical directions. However, all of the rolls, whether stationary or movable, are able to rotate with a controllable speed about their respective longitudinal axes.

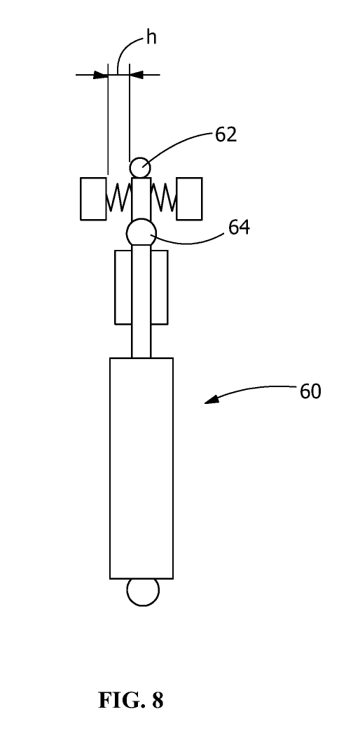

Servo controlled electric, or hydraulic, lift actuators cooperate with the movable or adjustable rolls 16, 20, 24, 28 to provide both nip pressure and gap control between the respective adjustable rolls 16, 20, 24, 28 and the respective fixed rolls 18, 22, 26. Coordinated control of these lift actuators provides the capability to set the gap between each roll pair, independently. In the embodiments shown in FIGS. 1 through 4, one lift actuator is provided on each end of each adjustable roll 16, 20, 24, 28. The lift actuator is located in such a way as to provide both stiffness and precise position control to create a final uniform nipping gap 32, 34, 36, 38, 40, 42. The lift actuator for roll 16 moves in an inclined angle to create the primary nip 32 between roll 16 and 18. In contrast, lift actuators 60 (FIG. 8) for rolls 20, 24 have vertical movements that create additional nipping function, or calibration for final web thickness.

Mechanical stops (not shown) may be provided to properly datum (or zero) position the adjustable rolls 20, 24 such that the centers of adjustable rolls 20, 24 are located on the same horizontal line as the center of fixed rolls 18, 22, 26, as shown in FIG. 1.

In the embodiment shown in FIGS. 1 and 2, the roll 28 has horizontal movement that not only creates a final nipping between roll 26 and 28, but also provides a force that removes the possible deflections for all upstream rolls. The horizontal movement of roll 28 minimizes frame deflections as the force applied by roll 28 to the material 30 is opposite with the direction of roll and frame deflection associated with additional nipping force between each pair of adjacent rolls.

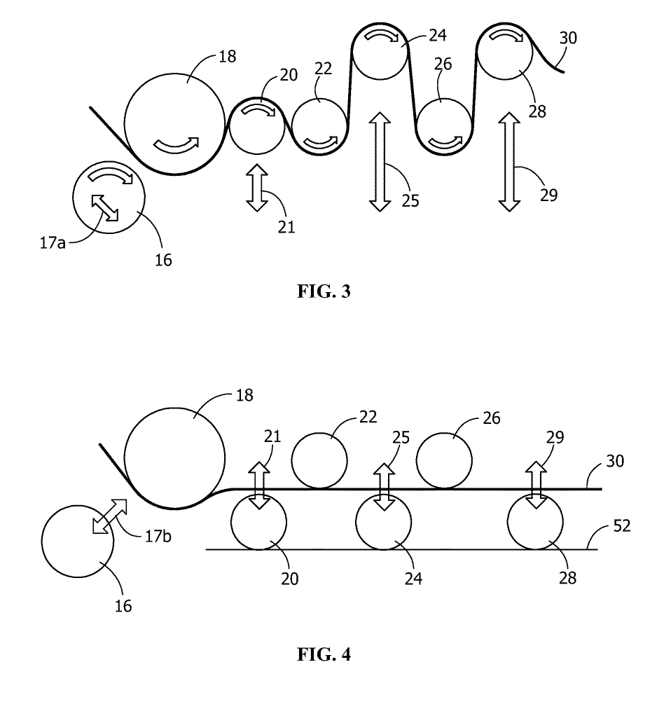

In the embodiment shown in FIGS. 3 and 4, the roll 28 has vertical movement similar to roll 24. In this embodiment, a final safety gap may be provided between respective adjacent rolls to allowable the adjustable rolls 24, 28 to be moved through the space between the fixed rolls without damaging any of the rolls, as is illustrated in FIG. 3.

In various embodiments, the rolls 16, 18, 20, 22, 24, 26, 28, or any combination thereof, may be enclosed, so that no operator can come in contact with the rolls during normal operating mode, including, but not limited to, startup and shutdown.

As shown in FIGS. 2 and 4, to support ease of thread up, the adjustable cooling rolls 20, 24 are moved to a retracted (down) position. In addition, as shown in FIG. 4, the adjustable roll 28, may also be moved to a retracted (down) position. In this position, the tops of the rolls 20, 24 are moved in line to facilitate an operator in threading up the machine with a starter sheet 30. This configuration provides an essentially or approximately level surface on which to push the starter sheet through the cooling section 10.

In other embodiments, a startup mode could also be provided that would run the rolls in reverse at a slow rate to help thread the cooling section 10 and the calendaring device 12. Alternatively, one or more of the cooling rolls may be closed as starter sheet passes over them to further assist with threading material back through the cooling section 10 and the calendaring device 12.

In the retracted position shown in FIG. 2, a cooling roll support frame 52 sits on what is in effect a permanently mounted homing or zeroing fixture for each roll. This allows the system to orient itself at power up without going through an elaborate homing sequence each time. During commissioning, the location of this home reference is recorded and sequences of movements are performed to define the operating space available to the position controller (not shown) of each roll. This consists of moving the adjustable rolls upward in a slow and controlled manner until the hard stops on each of the adjacent rolls are encountered. In one exemplary embodiment, as shown in FIG. 1, the uppermost position of the adjustable cooling rolls 20, 24 places the centerline of the adjustable rolls 20, 24 in line with the centerline of the adjacent stationary rolls 22, 26 with approximately 0.002 inch clearance provided between the roll faces. This position is referenced as the home position and recorded to define the entire operating space and to eliminate the need for performing this routine each time the control system is powered up. Once calibrated, the rollers 20, 24 may be moved to an operating position, which may vary depending upon the material and other such variables.

Adjustable nipping on each pair of respective adjacent rolls 20, 22, 24, 26, 28 may be provided. This allows for a gradual change to the thickness of web of material 30 until it reaches the final nipping roller 28, thereby reducing the initial nipping load of the first two polishing or smoothing rolls 16, 18. The reduction in load allows the size of first two polish rolls 16, 18 and the power needed to drive them to be reduced, resulting in energy and cost savings.

The velocity or speed of the rotation of each respective roll 20, 22, 24, 26, 28 will be consistent with other rolls or will vary between rolls. If the speed of the material is varied, the roll speed must be increased in the downstream rolls to keep a tension on the web of the material (for example, roll 28 has a roll speed greater than the roll speed of roll 20). If the volume flow rate is to be kept constant, the volume flow rate is used as a factor to determine the different speeds of each pair of rolls. In addition, if each pair of small rolls is to perform a nipping function, the volume flow rate must be controlled. In such applications, the roll speed must be calculated based on a percentage of nipping versus percentage of the volume flow rate accordingly.

In many applications, when it is not necessary for thin gauge web processing, the number of calibration and cooling rolls with close nipping can be reduced. For example, the configuration shown in FIG. 1 can be adjusted individually for each of small rolls to keep only a pair of calibration rolls 20, 22 where the web of material on exiting roll 22 reaches the glass transition temperature of plastic. No further calibration is required. Consequently, the cooling rolls 24, 28 can be moved further far away from fixed rolls 26 so that an equal wrap angle is kept with uniform cooling on both sides of the web of material but the cooling length of the web of material is increased as more distance between is provided between rolls 24, 26 28, as shown in FIG. 3.

In the embodiment shown in FIGS. 1 and 2, roll 16 is a primary polish or smoothing roll which is movable at a 45 degree incline relative to roll 18. Roll 16 has a skewing device. Roll 18 is a fixed primary polish or smoothing roll with a larger diameter for less deflection. Roll 20 is an adjustable positioning roll with both calibration and cooling functions which is movable vertically and which floats horizontally. Rolls 22, 26 are fixed calibration and cooling rolls. Roll 24 is an adjustable calibration and cooling roll which is movable vertically and which floats horizontally. Roll 28 is an adjustable calibration and cooling roll which is movable horizontally which facilitates the removal of roll deflection from previous rolls.

In the embodiment shown in FIGS. 3 and 4, roll 16 is a primary polishing or smoothing roll which is movable at a 45 degree incline relative to roll 18. Roll 16 has a skewing device. Roll 18 is a fixed primary polish or smoothing roll with a larger diameter for less deflection. Roll 20 is an adjustable positioning roll with both calibration and cooling functions which is movable vertically. Roll 22 is a fixed calibration and cooling roll. Roll 26 is a fixed cooling roll. Roll 24 is an adjustable cooling roll which is movable vertically. Roll 28 is an adjustable cooling roll which is movable vertically.

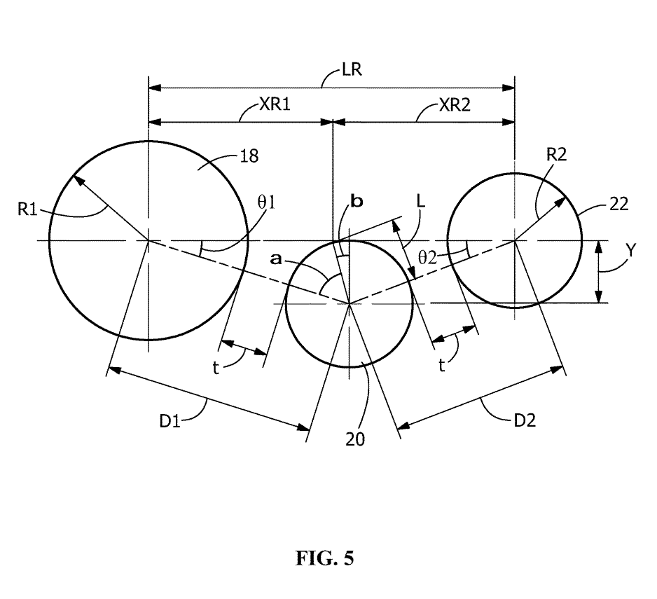

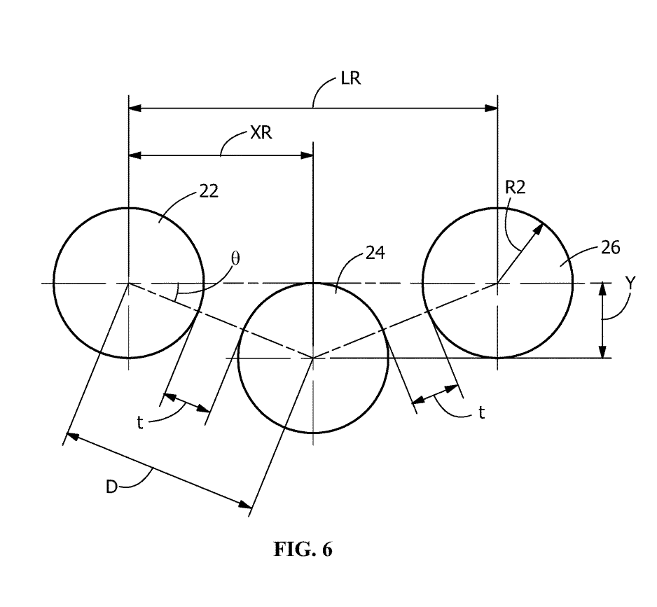

Referring to FIG. 5, an enlarged diagrammatic view of the primary polish roll 18, the adjustable positioning, calibration and cooling roll 20 and the fixed calibration and cooling roll 22 is shown. In this figure, the following symbols are used:
LR—Overall horizontal distance between the centers of fixed primary roll 18 and the fixed calibration roll 22;
XR1—Fixed distance between center of the fixed primary roll 18 and the adjustable positioning, calibration and cooling roll 20 when the horizontal center line of all rolls are in the same plane;
XR2—Fixed distance between center of the adjustable positioning, calibration and cooling roll 20 and the fixed calibration roll 22 when the horizontal center line of all rolls are in the same plane;
R1—Fixed primary roll 18 diameter;
R2—Diameter of all position & calibration rolls, including the adjustable positioning, calibration and cooling roll 20 and the fixed calibration roll 22;
Y—Vertical distance between the center of the fixed primary roll 18 and the adjustable positioning, calibration and cooling roll 20;
L—Stroke of a movable calibration actuator of the adjustable positioning, calibration and cooling roll 20 to keep the same thickness among rolls;
D1—Center distance between the fixed primary roll 18 and the adjustable positioning, calibration and cooling roll 20;
D2—Center distance between the adjustable positioning, calibration and cooling roll 20 and fixed calibration roll 22;
t—Thickness between rolls (assumed to be the same between all rolls in this figure);
α—Angle between a line extending between the center of the fixed primary roll 18 and adjustable positioning, calibration and cooling roll 20 and the line between the zero position and any operational position of the adjustable positioning, calibration and cooling roll 20 stroke;
β—Angle between a vertical line and the line between the zero position and any operational position of the adjustable positioning, calibration and cooling roll 20 stroke;
θ1— Angle between the horizontal center line of the fixed primary roll 18 and a line extending between the center of the fixed primary roll 18 and the center of the adjustable positioning, calibration and cooling roll 20;
θ2—Angle between the horizontal center line of the fixed calibration roll 22 and a line extending between the center of the fixed calibration roll 22 and the center of the adjustable positioning, calibration and cooling roll 20.

Referring to FIG. 6, an enlarged diagrammatic view of the fixed calibration and cooling roll 22, the adjustable calibration and cooling roll 24 and the fixed cooling roll 26 is shown. In this figure, the following symbols are used:
LR—Overall horizontal distance between the centers of fixed calibration and cooling roll 22 and the fixed cooling roll 26;
XR—Fixed horizontal distance between center of the adjustable calibration and cooling roll 24 and the fixed calibration and cooling roll 22;
R2—Diameter of all position & calibration rolls, including the fixed calibration and cooling roll 22, the adjustable calibration and cooling roll 24 and the fixed cooling roll 26;
Y—Vertical distance between the center of the fixed cooling roll 26 and the adjustable calibration and cooling roll 24;
D—Center distance between the fixed calibration and cooling roll 22 and the adjustable calibration and cooling roll 24;
t—Thickness between rolls (assumed to be the same between all rolls in this figure);
θ—Angle between the horizontal center line of the fixed calibration and cooling roll 22 and a line extending between the center of the fixed calibration and cooling roll 22 and the center of the adjustable calibration and cooling roll 24.

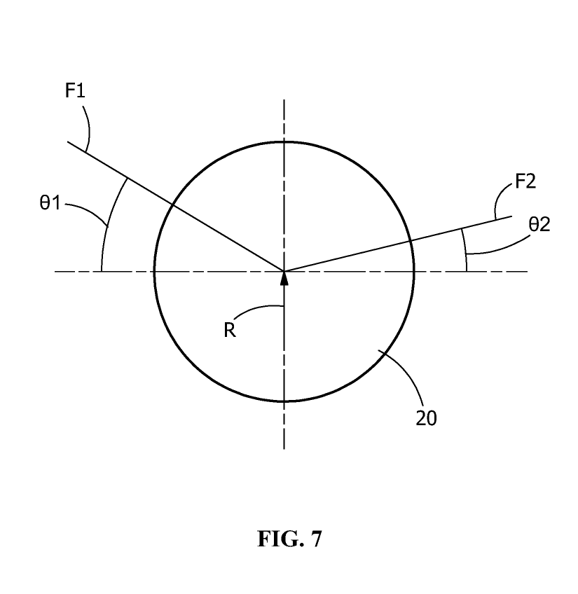

Referring to FIG. 7, a schematic view of the forces acting on the calibration and cooling roll 20 for the configuration shown in FIG. 1. In this figure, the following symbols are used:
F1—Force applied to the calibration and cooling roll 20 from the primary polish roll 18;
F2—Force applied to the calibration and cooling roll 20 from the fixed calibration and cooling roll 22;
R—Reacting force from the actuator of the adjustable positioning, calibration and cooling roll 20 to balance F1 and F2.

Referring to FIG. 8, a diagrammatic view of an actuator 60 is shown. In this figure, the following symbols are used:
h—gap on both sides for floating connection of the end of actuator

Referring to FIG. 5, the geometric relationship is displayed for the primary polish roll 18, the adjustable positioning, calibration and cooling roll 20 and the fixed calibration and cooling roll 22. The center distance “D1” between primary polish roll 18 with a radius “R1”, and the adjustable positioning, calibration and cooling roll 20 with a radius “R2” is equal:

D1=R1+R2+t (1)

And the center distance “D2” between the adjustable positioning, calibration and cooling roll 20 and the fixed calibration and cooling roll 22 is,

D2=2×R2+t (2)

There is a fixed zero position for the adjustable positioning, calibration and cooling roll 20 where the center of the adjustable positioning, calibration and cooling roll 20 is located in the same horizontal plane as the center of the fixed calibration and cooling roll 22. In this position, a final mechanical safety gap “δ” between the fixed primary roll and fixed calibration roll is provided. In the embodiment shown in FIG. 1, the safety gap is:

δ=0.002″

The fixed distance “XR1” that determines the zero position of movable roll is:

XR1=R1+R2+δ (3)

With the same definition, the fixed distance “XR2” is:

XR2=2×R2+δ (4)

The distance “LR” between the primary polish roll 18 and the fixed calibration and cooling roll 22 is:

LR=XR1+XR2 (5)

The frame on which the primary polish roll 18, the adjustable positioning, calibration and cooling roll 20 and the fixed calibration and cooling roll 22 are positioned is configure such that the “XR1”, “XR2”, and “LR” will be made precisely from machining and assembly. Consequently, the stroke “L” of actuator of the adjustable positioning, calibration and cooling roll 20 is the control variable that can be calculated as follows:

L=\sqrt{D1²+XR1²−2×D1×XR1×cos(θ1)} (6)

### Where, “θ1” is:

$$θ 1 = {cos}^{- 1} ( \frac{D {1}^{2} + {LR}^{2} - D {2}^{2}}{2 \times D 1 \times LR} ) \qquad ( 7 )$$

The “L” position is varied with the angle θ1, and is determined by the equal gap “t” on each pair of rolls. Consequently, the guiding path will be given by both parameter of “L” and “β”. Since the angle “β” is different on each position of “L”, angle “β” needs to be calculated through angle “α” as the following:

$$α = {sin}^{- 1} ( \frac{XR 1 \times sin ( θ 1 )}{L} ) \qquad ( 8 )$$

And, then:

β=90°−θ1−α (9)

Based on the above, the location of the top end of each actuator for the adjustable positioning, calibration and cooling roll 20 is determined.

Referring to FIG. 6, the geometric relationship is displayed for the fixed calibration and cooling roll 22, the adjustable calibration and cooling roll 24 and the fixed cooling roll 26. While the relationship has similarities to the relationship described above, the relationship is simpler, as all rolls are designed with the same diameter, and the adjustable calibration and cooling roll 24 is centered between the fixed calibration and cooling roll 22 and the fixed cooling roll 26. Therefore, using the parameters shown in FIG. 6, the center distance between fixed calibration roll and movable calibration roll “D” is given:

D=2×R2+t (10)

The fixed distance “XR” and “LR” are,

XR=2×R2+δ (11)

LR=2×XR (12)

The stroke is truly vertical and the stroke “Y” is:

Y=\sqrt{D²−XR²} (13)

And the variable angle “θ” is give,

$$θ = {tg}^{- 1} ( \frac{Y}{XR} ) \qquad ( 14 )$$

As the angles “θ1”, “θ2”, and “θ” are small, the force required to be supplied from the actuator is significantly less than the nipping force. As an examples, with each of the angles “θ1”, “θ2”, and “θ” less than 6 degrees for the thin gauge web of 0.05″, the force required to be supplied from the actuator is less than 10% of the nipping force The force “R” of actuator, as shown in FIG. 7, is as follows:

$$R = F 1 \times ( sin ( θ 1 ) + \frac{cos ( θ 1 )}{cos ( θ 2 )} ) \qquad ( 15 )$$

As the nipping force “F1” is given by the material processing, for example about 800 to 1000 lbf/in for thin gauge PP processing and all the angles in the equation (15) are calculated as described above, the actuator force “R” is known.

The forces from the primary polish roll 18 and the fixed calibration and cooling roll 22 are different since the angle “θ1” and “θ2” are different. With force “F1” is determined, force “F2” is given by:

$$F 2 = \frac{F 1 \times cos ( θ 1 )}{cos ( θ 2 )} \qquad ( 16 )$$

For the roll configuration shown in FIG. 6, all forces from each roll are the same, and the angle “θ” is the same. The force balance relationship is as the following:

R=2×F×sin(θ) (17)

Where, the “F” is equal to “F2” in equation (16) since an equal nipping force is required in each pair of calibration rolls.

Referring to FIG. 8, an embodiment is shown which provides a floating connection on the end of actuator. There is a gap “h” on both sides of the end of actuator 60 so that the movable roll center 62 can swivel with a distance of “h” related to pivot point of 64 of the actuator. This allows a floating connection that will keep the equal thickness “t” between two stationary rolls when movable roll is engaged in the working position for multi-nipping or calibration. Therefore, the nipping gap will automatically adjust by force balance in each pair of rolls.

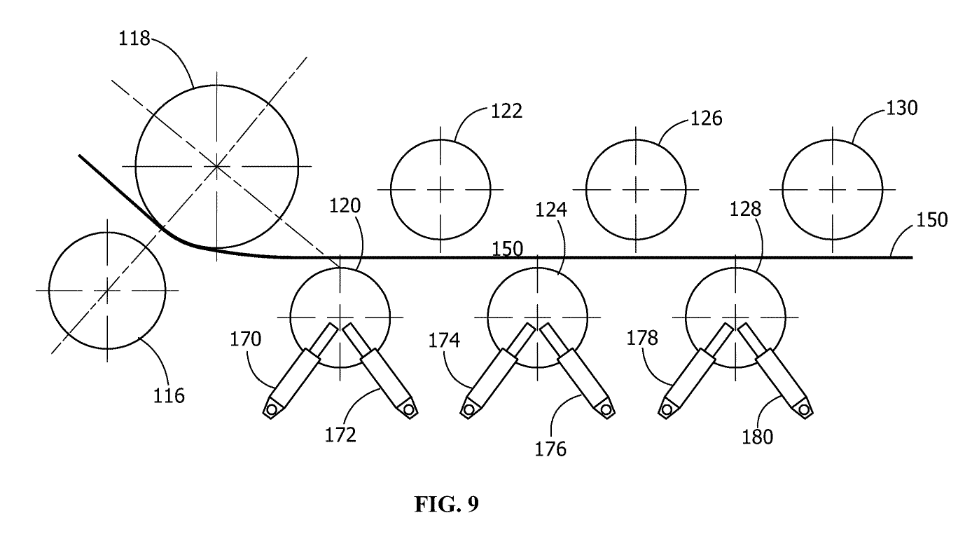

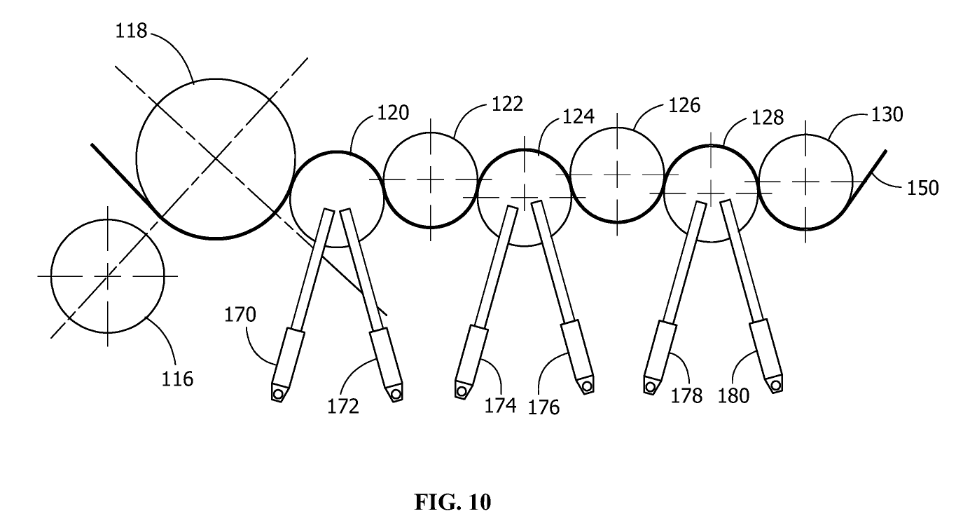

An alternate embodiment is shown in FIGS. 9 and 10. In this embodiment, primary rolls 116, 118 and material 150 operate in a similar manner to primary rolls 16, 18 and material 30 respectively. Cooling rolls 122, 126, 130 are stationary and cooling rolls 120, 124, 128 are movable both vertically and horizontally to create the required gap between the adjacent roll pairs. A pair of servo controlled electric or hydraulic lift cylinders 170, 172 provides both nip pressure and gap control to roll 120. A pair of servo controlled electric or hydraulic lift cylinders 174, 176 provides both nip pressure and gap control to roll 124. A pair of servo controlled electric or hydraulic lift cylinders 178, 180 provides both nip pressure and gap control to roll 128. Coordinated control of these lift cylinders provides the capability to set the gap between each roll pair independently. In the embodiment shown, two lift cylinders for each movable roll 120, 124, 128 are provided on each end of a roll support frame. The lift cylinders are located in such a way as to provide stiffness in all three dimensions (X, Y & Z).

While the invention has been described with reference to a preferred embodiment, it will be understood by those skilled in the art that various changes may be made and equivalents may be substituted for elements thereof without departing from the spirit and scope of the invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A multi-nip takeoff and cooling section comprising:
a first smoothing and a second smoothing roll;
a position, calibration and cooling roll positioned proximate to the second smoothing roll, the position, calibration and cooling roll being movable relative to the second smoothing roll;
a first fixed calibration and cooling roll positioned proximate the position, calibration and cooling roll, the first fixed calibration and cooling roll being in a fixed position relative to the second smoothing roll;
a first movable calibration and cooling roll positioned proximate the first fixed calibration and cooling roll, the first movable calibration and cooling roll being movable relative to the first fixed calibration and cooling roll; and
a second fixed calibration and cooling roll positioned proximate the first movable calibration and cooling roll, the second fixed calibration and cooling roll being in a fixed position relative to the second smoothing roll.

2. The multi-nip takeoff and cooling section as recited in claim 1, wherein a first movable cooling roll is positioned proximate the second fixed calibration and cooling roll, the first movable cooling roll being movable relative to the second fixed calibration and cooling roll.

3. The multi-nip takeoff and cooling section as recited in claim 1, wherein the first smoothing roll is movable relative to the second smoothing roll.

4. The multi-nip takeoff and cooling section as recited in claim 1, wherein the first smoothing roll has a diameter which is smaller than a diameter of the second smoothing roll.

5. The multi-nip takeoff and cooling section as recited in claim 1, wherein the position, calibration and cooling roll has a diameter which is smaller than the diameter of the second smoothing roll.

6. The multi-nip takeoff and cooling section as recited in claim 1, wherein the first fixed calibration and cooling roll, the first movable calibration and cooling roll, and the second fixed calibration and cooling roll have diameters which are essentially equal to the diameter of the position, calibration and cooling roll.

7. The multi-nip takeoff and cooling section as recited in claim 1, wherein actuators cooperate with the position, calibration and cooling roll and the first movable cooling roll to provide both nip pressure and gap control between the second smoothing roll, the position, calibration and cooling roll and the first fixed calibration and cooling roll and between the first fixed calibration and cooling roll, the first movable calibration and cooling roll and the second fixed calibration and cooling roll.

8. The multi-nip takeoff and cooling section as recited in claim 2, wherein the first movable cooling roll moves vertically and horizontally relative to the second smoothing roll to provide an angle between first movable cooling roll and the second smoothing roll which results in a balanced force and varied gaps between the first movable cooling roll and the second smoothing roll that compensates for deflections for the first fixed calibration and cooling roll and the first movable calibration and cooling roll.

9. The multi-nip takeoff and cooling section as recited in claim 1, wherein the first fixed calibration and cooling roll and the second fixed calibration are spaced apart to provide clearance for the first movable calibration and cooling roll to be moved between the first fixed calibration and cooling roll and the second fixed calibration.

10. The multi-nip takeoff and cooling section as recited in claim 1, wherein the first fixed calibration and cooling roll, the first movable calibration and cooling roll and the second fixed calibration and cooling roll are offset vertically.

11. The multi-nip takeoff and cooling section as recited in claim 1, wherein when the position, calibration and cooling roll and the first movable calibration and cooling roll are in a retracted position, the position, calibration and cooling roll and the first movable calibration and cooling roll engage stops, allowing the multi-nip takeoff and cooling section to orient itself at power up.

12. A multi-nip takeoff and cooling section comprising:
a first smoothing and a second smoothing roll;
a position, calibration and cooling roll positioned proximate to the second smoothing roll, the position, calibration and cooling roll being movable relative to the second smoothing roll;
a first fixed calibration and cooling roll positioned proximate the position, calibration and cooling roll, the first fixed calibration and cooling roll being in a fixed position relative to the second smoothing roll;
a first movable calibration and cooling roll positioned proximate the first fixed calibration and cooling roll, the first movable calibration and cooling roll being movable relative to the first fixed calibration and cooling roll; and
actuators cooperate with the position, calibration and cooling roll and the first movable cooling roll to provide both nip pressure and gap control between the second smoothing roll and the position, calibration and cooling roll, between the position, calibration and cooling roll and the first fixed calibration and cooling roll, and between the first fixed calibration and cooling roll and the first movable calibration.

13. The multi-nip takeoff and cooling section as recited in claim 12, wherein a second fixed calibration and cooling roll is positioned proximate the first movable calibration and cooling roll, the second fixed calibration and cooling roll being in a fixed position relative to the second smoothing roll, a first movable cooling roll is positioned proximate the second fixed calibration and cooling roll, the first movable cooling roll being movable relative to the second fixed calibration and cooling roll, actuators cooperate with the first movable cooling roll to allow the first movable cooling roll to move vertically and horizontally relative to the second smoothing roll to provide a balanced force and varied gap along the axis of roll that removes deflections for the position, calibration and cooling roll, the first fixed calibration and cooling roll, the first movable calibration and cooling roll and the second fixed calibration and cooling roll.

14. A method for nipping and cooling plastic sheet material, the method comprising:
running the plastic sheet material through polishing rolls;
running the plastic sheet material through calibration and cooling rolls;
adjustably nipping on each pair of respective calibration and cooling rolls, allowing for a gradual change to the thickness of sheet material until sheet material reaches a final calibration and cooling roll;
whereby the initial nipping load of the polishing rolls is reduced, allowing the size of the polishing rolls and the power needed to drive them to be reduced.

15. The method of claim 12, comprising:
controlling speed of the rotation of each respective calibration and cooling rolls to be consistent with other of the calibration and cooling rolls.

16. The method of claim 12, comprising:
varying speed of the rotation of each respective calibration and cooling rolls relative to other of the calibration and cooling rolls.

17. The method of claim 14, comprising:
increasing the speed of rotation in respective calibration and cooling rolls which are removed from the polishing rolls to keep a tension on the plastic sheet material.

18. The method of claim 15, comprising:
calculating the desired speed of rotation based on a percentage of nipping of the sheet material versus percentage of the volume flow rate of the sheet material.

19. The method of claim 12, comprising:
positioning respective calibration and cooling rolls which are removed from the polishing rolls so that an equal wrap angle is maintained with uniform cooling on both sides of the sheet material.

20. The method of claim 12, comprising:
retracing adjustable calibration and cooling rolls such that tops of the adjustable calibration and cooling rolls are moved in line with a series of idler rolls to facilitate an operator in threading the sheet material through the calibration and cooling rolls by providing a level surface on which to push the sheet material through the machine.
